(19) United States
(12) Patent Application Publication
(10) Pub. No.: US 2005/0238561 A1
(43) Pub. Date: Oct. 27, 2005

(54) Process for the production of highly organized crystals by means of Sol-Gel methods

(75) Inventors: Wolfram Beier, Essenheim (DE); Rupert Schnell, Worms (DE)

Correspondence Address: CHARLES N.J. RUGGIERO, ESQ.;OHLANDT, GREELEY, RUGGIERO & PERLE, L.L.P., 10th FLOOR, ONE LANDMARK SQUARE, STAMFORD, CT, 06901-2682, US

(73) Assignee: SCHOTT GLASS

(21) Appl. No.: 11/074,224

(22) Filed: Mar. 7, 2005

Related U.S. Application Data
(63) Continuation of application No. PCT/EP03/09335, filed on Aug. 22, 2003.

(30) Foreign Application Priority Data
Sep. 7, 2002 (DE) 102 41 494.7
Aug. 2, 2003 (DE) 203 11 944.4
Aug. 2, 2003 (DE) 203 11 937.1
Aug. 2, 2003 (DE) 203 11 939.8
Aug. 2, 2003 (DE) 203 11 940.1
Aug. 2, 2003 (DE) 203 11 942.8
Aug. 2, 2003 (DE) 203 11 943.6

(51) Int. Cl. C01B 33/12; C11D 17/06

(52) U.S. Cl. 423/338

(57) ABSTRACT

The invention provides a process for the production of materials with a crystal-like superstructure or an inverse crystal-like superstructure, particularly photonic crystals, wherein—the materials with crystal-like superstructure are obtained by self-organization or induced, controlled processes—and—by hypercritical drying.

The invention relates to materials with crystal-like superstructure, particularly photonic crystals, which are obtained by self-organization, and in fact, by self-organization of the particles that make up the photonic crystal itself or by sol-gel infiltration into a preform, a so-called template, a process for the production thereof, as well as the use of such crystals.

Photonic crystals are materials that have a crystal-like superstructure with a photonic band gap and hence forbidden or inaccessible energy states for photons; that is, light of certain frequency cannot propagate in all directions in space. Photonic crystals, which have an optical band gap of this kind, are characterized by a regular three-dimensional periodic lattice structure, which consists of regions with strongly fluctuating refractive indices. In principle, there exist various processes for the production of photonic crystals. One possibility for the production of photonic crystals consists of the use of micromechanical processes. Here, for example, a silicon wafer can be coated with silicon dioxide and uniform troughs can be cut in it and filled with polysilicon. The surface can then be polished and covered again with SiO₂ and uniform polysilicon strips can likewise be structured therein, albeit at a right angle to the underlying layer. By repeating this process a number of times, it is possible in this way to prepare crosswise double layers. The SiO₂, as the support material, can be dissolved out with hydrofluoric acid, so that a cross lattice structure made out of polysilicon with regular cavities results. In this regard, reference is made, for example, to R. Sietmann, “Neue Bauelemente durch photonische Kristalle” [New Components through Photonic Crystals], Funkschau 26, 1998, pp. 76-79, or to “Silicon-based photonic crystals” by Albert Birner, Ralf B. Wehrspohn, Ulrich M. Gösle, and Kurt Busch, Advanced Materials 2001, 13, No. 6, pp. 377-388.

An entirely different kind of production of photonic crystals is the construction of photonic crystals by means of self-organizing or induced, controlled processes. Self-organizing or induced, controlled processes of this kind are known from the field of colloidal crystals, which are made up, for example, of titanium dioxide or silicon dioxide colloids or polymer colloids. The colloidal crystals form spontaneously under suitable conditions of temperature and pressure. They have a regular three-dimensional superstructure with submicrometer periodicity. The structural elements of colloidal crystals are, for example, polymers—e.g., polystyrene spheres with a size of 10 nm to 10 μm. Conventionally, colloidal crystals of this kind are prepared by sedimentation, this leading to thick polycrystalline samples within a liquid. Subsequently, the liquid in the sedimented colloidal structures, consisting of the structural elements mentioned above, is removed, so that there result cavities between the structural elements, that is, for example, the polymer spheres. Photonic crystals prepared in this way have domains with a size of up to several centimeters (cm).

In an alternative process, the capillary forces at the meniscus of a colloidal solution and of a substrate are used to draw colloids into close-packed structures by means of self-organization. A drawback of this known process of the prior art for the production of highly organized, particularly photonic crystals by micromechanical methods is the high expense.

In the known processes for preparing highly organized crystals through self-organization, the problem consisted of the fact that, during drying of the colloidal superstructure, the fluid in the cavities could be drawn off only very poorly and, in particular, over a very long period of time.

Photonic crystals that are prepared by sol-gel infiltration into a preform, a so-called template, also have the tendency to decompose into small fragments during the drying process. This is particularly true for samples with larger dimensions, that is, a layer thickness greater than 1 μm. Samples of this kind can become cracked or even decompose to powders, unless the drying process is carried out very carefully and very slowly over months at a time.

In regard to sol-gel processes that are employed for the sol-gel infiltration of a preform for the production of glasses, glass ceramics, ceramics, and composite materials, reference is made to the following documents:
Prospects of Sol-Gel Processes, by Donald R. Ulrich, Journal of Non-Crystalline
Solids 100 (1988), pp. 174-193,
Charakterisierung von SiO₂-Gelen und-Gläsern, die nach der Alkoxid-Gel-Methode hergestellt wurden [Characterization of SiO₂ Gels and Glasses
Which Were Prepared by the Alkoxide-Gel Method], by Wolfram Beier,
Martin Meier, and Günther Heinz Frischat, Glastechnische Berichte 58 (1985),
No. 5, pp.97-105
Glaschemie [Glass Chemistry] by Werner Vogel, Springer Publishing Co., Berlin,
Heidelberg, N.Y., 1992, pp. 229-233

In the production of highly organized crystals—for example, photonic crystals—by sol-gel infiltration, that is, by means of a sol-gel process, a sol is formed in the first step of the process. Sols are colloidal suspensions of solid and liquid substances in a liquid or gaseous dispersant, the particle sizes lying between 5×10⁻¹⁰ and 2×10⁻⁷ m. Because colloidal solutions of this kind are, as a rule, unstable, the particles agglomerate and a gel is formed. In order to obtain a photonic crystal, the resulting gel must be dried; that is, the liquid components have to be removed from the cavities of the gel. During drying of the gels, enormous stresses arise as a rule, which can destroy the basic framework.

Interference layer systems have been used in the prior art as wavelength-selective IR blockers or UV blockers. These materials have had the drawback that they had to be prepared in a very complicated manner. For example, in the case of multilayer systems for IR blockers or a 3-layer system for a UV blocker, it is necessary that a substrate support be dipped in repeated succession into different solutions. If the layers are vapor-deposited by, for example, a CVD or PVD process, then the vaporized materials have to be exchanged.

Used in the prior art as catalyst supports are materials whose cavities have a broad size distribution. Catalyst supports of this kind made from zeolites, for example, have a high flow resistance.

In the prior art, open-pored sintered glasses, for example, are employed at the present time for the immobilization of bacteria and other biological, microbiological, bioprocess technological, as well as medical applications and for water purification and water treatment. Sintered glasses of this kind are marketed by the company SCHOTT GLAS, Mainz, under the trade names SIRAN® and are described, for example, in the article “Bioreaktoren in der Abwassertechnik” [Bioreactors in Wastewater Engineering] by M. Radke in EntsorgungsPraxis 10/89. These materials have had the drawback that they always had a relatively broad size distribution of their cavities, so that the selection has not been highly specific.

As color effect coatings in the prior art of metal, glass, or plastic surfaces, lacquers mostly contain, in addition to the coloring pigments, metallic particles, e.g., aluminum powder, in order to achieve a metallic luster. Owing to the variation in size of these particles and, in particular, to the addition of large aluminum particles and plastic particles, it is possible, furthermore, to bring about a brilliant effect. In order to enhance the color effects and, in particular, to attain an iridescent optical effect in connection with a pearly luster effect, the color pigments can take the form of flakes and be vapor-deposited with metal.

Lacquer coatings in accordance with the prior art that have high photodynamics, that is, lacquers with luster effects or those that convey a perceived color that depends on the light incidence and the direction of view are characterized by an especially involved production and by a limitation in the design of the color effects.

Alternatively, in accordance with the prior art for transparent or partially transparent materials, such as, for example, glasses or plastic foils, it is possible to incorporate additives with iridescent color effect into the material during the production. A traditional example of this is Tiffany glass from the Jugendstil period, which iridesces in a rainbow of colors and has a metallic luster and which was produced mostly by means of vapors of various mixed metal salts. However, a drawback here is that the color effect cannot usually be controlled in a precise manner, because these effects are dependent on the details of the formation of the metal colloids in the glass matrix. The limitations that ensue from this for the selection of the glass materials and the conditions of production are to be regarded as a disadvantage.

One possibility of coloring a surface without depositing pigments in accordance with the prior art consists of the use of interference layer systems, which are characterized by a wavelength-selective reflection. However, interference layer systems entail an involved manufacture, because each layer has to be applied or vapor-deposited by itself and, in addition, the layer sequence of an interference layer system, which alternates in only one direction, does not allow the creation of color effects.

A first object of the invention is to provide a process for the production of highly organized, particularly photonic crystals, by means of which the disadvantages of the prior art can be overcome, in particular, the drying of the self-organized crystal-like superstructures and of the inverse crystal-like superstructures prepared by sol-gel infiltration should occur without damage and more rapidly than in the prior art. In particular, a damaging of inverse crystal-like superstructures prepared by the sol-gel process should be prevented during drying.

Another object of the invention is to overcome the disadvantages of conventional materials that are used as IR blockers and UV blockers. In particular, it should be possible to prepare IR blockers and/or UV blockers in a simple way in that, for example, a dispersion, which is deposited one time onto a substrate—for example, window glass—is sprayed on or applied by spin-on deposition.

Another object of the invention consists of overcoming the disadvantages of conventional porous materials as catalyst supports in chemical and process engineering applications and as material for water purification and water treatment as well as for the immobilization of bacteria and other biological, microbiological, bioprocess technological, as well as medical applications. To be made available in particular are catalyst supports that have a low flow resistance as well as open-porous materials that can be influenced in terms of their functionality in such a way that a colonization with specific, selected microorganisms can be achieved in a targeted manner and in such a way that these microorganisms can be immobilized.

In accordance with the invention, the first object is solved in that the highly organized, crystal-like superstructures or inverse crystal-like superstructures are subjected to a hypercritical drying. The crystal-like superstructures are also referred to as a structure or a clumped structure.

A hypercritical drying results in a more rapid drawing off of the liquid from the crystal-like superstructures. In addition to this, a damaging of the structure, particularly of the inverse structures, is prevented during drying.

In regard to hypercritical drying, reference is made to Fricke J., “Aerogele—eine faszinierende Klasse hochporöser Materialien [Aerogels—a Fascinating Class of Highly Porous Materials] in Umschau 1986, No. 7, pp. 374-377, as well as Fricke J., “Aerogels—highly tenuous solids with fascinating properties,” Journal of Non-Crystalline Solids 100 (1988), pp. 169-173.

Exploited in hypercritical drying is the circumstance that, above the critical point, the solid/liquid phase boundary is eliminated and only a single phase then exists; that is, above the critical temperature, a gas, for example, can no longer be liquefied regardless of how high the pressure is.

Because the cracking of a gel during drying can be ascribed essentially to differently high capillary forces in the pores of different sizes of the gel, a hypercritical drying makes it possible to achieve the situation that there no longer arise any differences in stress in the solid being dried. A cracking of the solid is prevented in this way. As discussed above, there exists only a single gaseous/liquid phase above the critical point and thus capillary forces no longer exist, which might arise at a gaseous/liquid phase boundary. The single gaseous/liquid phase can then be drawn off from the pores of the gel without destruction of the solid during drying.

Known from U.S. Pat. No. 5,795,557 is the production of aerogels from silicic acid. It is pointed out in U.S. Pat. No. 5,795,557 that aerogels can be obtained by sol-gel processes. The aerogel is obtained after drying, that is, after the alcohol has been separated off.

Described in U.S. Pat. No. 6,139,626 is the production of templates, that is, synthetic opals, and the filling of the pores of the template with colloidal nanocrystals. The colloidal nanocrystal solution contains at least one solvent, which is extracted.

U.S. Pat. No. 6,261,469 describes three-dimensional crystal structures of both smaller and larger dimensions, as well as photonic crystals, involving the application of infiltration processes and extraction steps. In U.S. Pat. No. 6,261,469, synthetic opals, inverse opals, and templates are prepared, for example, from SiO₂ spheres in colloidal suspension by sedimentation. Into these templates, the desired material—for example, a fluid—is then infiltrated. Mentioned in U.S. Pat. No. 6,139,626, as a preferred extraction process, is also supercritical fluid extraction. Supercritical fluid extraction, as described in U.S. Pat. No. 6,139,626, serves merely to remove the fluid more rapidly.

The hypercritical drying in accordance with a first aspect of the invention is conducted in such a way, however, that a drying of regularly arranged, self-organized or controlled, organized particle arrangements, particularly inverse crystal-like superstructures prepared by sol-gel infiltration, is made possible without any destruction. Conceivable as sol-gel processes are inorganic, organic, or hybrid processes, such as, for example, the Ormocer process. Hypercritical drying can also occur in several steps by, for example, solvent exchange.

Hypercritical drying is employed particularly for drying the self-organized or induced, organized crystal-like superstructures that are made up of, for example, polymer spheres and that can serve, in turn, as templates for materials of high refractivity. These templates can be infiltrated with materials of high refractivity according to the sol-gel method to provide an inverse crystal structure. By means of hypercritical drying of the infiltrated gel, low-shrinkage, crack-free inverse photonic crystals are obtained by molding. After the material of high refractivity, which, for example, has been incorporated into the template by sol-gel infiltration and, in accordance with the invention, has been dried in a hypercritical manner, the particles that form the template—for example, the polymer spheres—can be dissolved out of the inverse crystal structure in order to increase the difference in refractive index. The dissolving out is possible by baking, for example.

By means of the process of the invention, not only is a solvent rapidly extracted, such as described, for example, in U.S. Pat. No. 6,261,469, but also the structure is strengthened by hypercritical drying and the template, for example, is stabilized. It is then possible, for example, to obtain photonic crystals or templates that, without neck formation, form stable, higher order, periodic structures. Thus far, necks of this kind were necessary in photonic crystals for holding together, for example, their superstructures and for ensuring their mechanical stability.

The absence of neck pieces on account of the process of hypercritical drying of the invention has advantages in regard to optical properties and, in particular, when the particles that form the template are to be dissolved out, for example, by baking.

By means of the process of the invention, the production of optical components that have a photonic crystal superstructure with large dimensions as well as of three-dimensional, optical components that have a photonic crystal superstructure of complex form and/or structuring becomes possible.

In regard to the production of templates that can serve as a preform for the formation of crystal-like superstructures of solids with higher refractive index and that are referred to as so-called inverse opals, reference is made to “From Opals to Optics: Colloidal Photonic Crystals” by Vicky L. Colvin, MRS Bulletin/August 2001, pp. 637-641.

The disclosure content of all of the references mentioned above:
Richard Sietmann, “Neue Bauelemente durch photonische Kristalle” [New Components through Photonic Crystals], Funkschau 26, 1998, pp. 76-79.
“Silicon-based photonic crystals” by Albert Birner, Ralf B. Wehrspohn, Ulrich M.
Gösle, and Kurt Busch, Advanced Materials, 2001, 13, No. 6, pp. 377-388.
“From Opals to Optics: Colloidal Photonic Crystals” by Vicky L. Colvin, MRS,
Bulletin/August 2001, pp. 637-641
Prospects of Sol-Gel Processes, by Donald R. Ulrich, Journal of Non-Crystalline Solids 100 (1988), pp. 174-193
Charakterisierung von SiO₂-Gelen und -Gläsern, die nach der Alkoxid-Gel-Methode hergestellt wurden” [Characterization of SiO₂ Gels and Glasses
Which Were Prepared by the Alkoxide-Gel Method], by Wolfram Beier,
Martin Meier, and Günther Heinz Frischat, Glastechnische Berichte 58 (1985),
No. 5,pp. 97-105
Glaschemie [Glass Chemistry] by Werner Vogel, Springer Publishing Co., Berlin,
Heidelberg, N.Y., 1992, pp. 229-233
   is included to the full extent in the disclosure content of the present application.

A hypercritical drying of a gel can be achieved, for example, by means of the following process control in the case of tetramethyl orthosilicate, Si(OCH₃)₄ (TMOS), for the production of SiO₂ aerogels, which are introduced into the template to form an inverse crystal-like superstructure.

Initially, at constant temperature, the pressure P is increased very strongly to, for example, about 80 bars in the case of TMOS for the production of SiO₂ aerogels. Then, at a constantly maintained pressure, the temperature is increased to approximately 270° C. Under these conditions, the fluid can be forced out of the gel structure without the gel structure collapsing or shrinking, because a process control of this kind always occurs above the critical temperature T_{C} and only a liquid or gaseous phase is present. The withdrawal of the liquid or gaseous phase occurs when the pressure is lowered to atmospheric pressure. Once atmospheric pressure is attained, the temperature is lowered to room temperature.

Achieved by means of the process of the invention is a hypercritical drying in contrast to the supercritical fluid extraction described in the prior art. The process control in the case of supercritical fluid extraction is chosen in such a way that the fluid is rapidly drawn off, that is, extracted; in the case of hypercritical drying, the process control is chosen in such a way that the superstructure of the photonic crystal is stabilized, so that, for example, neck pieces, as in the prior art for photonic crystals, can be avoided and the superstructure is stable even without neck pieces of this kind.

Surprisingly, the inventors have found that materials that have a very regular superstructure and lead to an optical band gap not only can be employed for optoelectronic components, but also can be employed outstandingly in other fields of optics—for example, as blockers for IR radiation or UV radiation. A reason for this lies in the extremely narrow distribution of the characteristic dimensions of the cavities in photonic crystals, which enables arrangements of this kind to be highly wavelength-selective as line or band filters.

It is possible to prepare in various ways a porous material in the form of a photonic crystal that is employed as IR blocker. In a first process, particles—for example, polymer, silicon dioxide, or titanium dioxide particles—are added to a dispersant. The particles undergo organization in the dispersant through slow sedimentation to form crystal-like superstructures under self-control or induced control. Subsequently, the dispersant is removed by drying—for example, by hypercritical drying—and the self-organized crystal is stabilized. The self-organization in crystal-like superstructures in a dispersant is particularly advantageous in the case of silicon dioxide or titanium dioxide particles, because, for crystal-like superstructures of this kind, a large difference in refractive index exists between the particles themselves and the air-filled cavities.

In an alternative process, the photonic crystal can be prepared by sol-gel infiltration in a preform, a so-called template.

Photonic crystals that are prepared by sol-gel infiltration into a preform, a so-called template, in addition, have a tendency to decompose into small fragments during the drying process. This is true particularly for samples with large dimensions, that is, with a layer thickness of greater than 1 μm. Samples of this kind can develop cracks or even decompose to powders, unless the drying process is carried out very carefully and very slowly over months at a time.

In an especially preferred embodiment, the highly organized crystal-like superstructures or inverse crystal-like superstructures that are employed for UV blockers or IR blockers are subjected to a hypercritical drying.

By means of a hypercritical drying, a damaging of the structure, particularly the inverse structures, is prevented during the drying.

Surprisingly, the inventors have found, in addition, that materials that have a very regular superstructure and lead to an optical band gap can also be employed in entirely different fields than the field of optics and are superbly suited as catalyst supports in chemical and process engineering applications. In particular, catalysts with catalyst supports of this kind are characterized by a very low flow resistance. The reason for this lies in the extremely narrow distribution of the characteristic dimensions of the cavities in photonic crystals. In addition to this, on account of their narrow distribution of the characteristic cavities, arrangements of this kind are characterized in that they can influence chemical reactions in a highly selective manner. This is due to the fact that the size of the cavities or the pore size can be adapted to the dimensions of the atoms, molecules, or radicals involved in the reaction in question. Furthermore, through the control of the size of the cavities in the crystal-like superstructure, it is possible to adjust the flow rate exactly. Furthermore, through the use of so-called photonic crystals as catalyst supports in chemical and process engineering applications, it is possible to achieve a greater catalytic conversion capacity than for the unorganized porous materials and clumped structures known at the present time. Furthermore, it is possible, in the case of the colloidal crystals that have an optical band gap, to further develop and to condition them in a targeted manner in such a way that very special chemical reactions can be addressed through suitable structural parameters such as particle size, particle shape, particle spacing, porosity, etc.

It is possible to prepare a porous material in the form of a photonic crystal that can be employed as a catalyst support in chemical and process engineering applications by means of, for example, slow sedimentation in a dispersant and subsequent hypercritical drying.

Damage to the structure in particular is prevented by the hypercritical drying, In regard to hypercritical drying, reference is made to the statements made above.

The inventors have found, in addition, that materials that have a very regular superstructure and lead to an optical band gap are superbly suited also for the immobilization of bacteria and for other biological, microbiological, bioprocess technological, and medical applications. One reason for this lies in the extremely narrow distribution of the characteristic dimensions of the cavities in photonic crystals, which enables arrangements of this kind to immobilize bacteria, viruses, and other microorganisms and the precursors thereof in a highly selective manner. A further advantage of the use of so-called photonic crystals for the immobilization of bacteria and for other biological, microbiological, bioprocess technological, and medical applications lies in the fact that regular structures of this kind can be furnished with a greater loading capacity than for less-organized porous materials and clumped structures known at the present time. Furthermore, it is possible, in the case of colloidal crystals that have an optical band gap, to further develop and to condition them in a targeted manner in such a way that very special bacteria or viruses can be immobilized through suitable cavity sizes.

It is possible to prepare a porous material in the form of a photonic crystal that can be employed for the immobilization of bacteria and for other biological, microbiological, bioprocess technological, and medical applications by means of, for example, slow sedimentation in a dispersant and subsequent hypercritical drying.

On account of the extremely narrow distribution of the characteristic dimensions of the cavities in photonic crystals, these structures are suitable also for water purification and water treatment. Arrangements of this kind are highly selective owing to the extremely narrow distribution of the dimensions of the cavities. A further advantage of the use of so-called photonic crystals for water purification and treatment lies in the fact that such regular structures allow a greater throughput capacity than the unorganized porous materials and clumped structures known at the present time. Furthermore, it is possible to further develop and to condition the colloidal crystals that have an optical band gap in a targeted manner in such a way that the substrate material, the surface condition, and the structural parameters, that is, particle size, particle shape, particle spacing, porosity, etc., can be tailored to the application.

A porous material can be prepared in the form of a photonic crystal that can be employed for the purification and treatment of water by means of, for example, slow sedimentation in a dispersant and subsequent hypercritical drying, during which the dispersant is drawn off.

Color effect layers and a color effect coating constitute further surprising applications of photonic crystals. Layers or coatings of this kind, based on photonic crystals, are characterized by an intensive creation of color effect as well as color dynamics. The color effect coating is suited, in particular, for application to a plurality of large-surface and randomly shaped substrates.

It is possible to prepare a porous coating material that produces a color effect in the form of a photonic crystal in various ways. A first color effect coating in accordance with the invention is obtained in that particles—for example, polymer, silicon dioxide, or titanium dioxide particles—undergo organization in a dispersant to form crystal-like superstructures by means of slow sedimentation under self-control or induced control. In this process, the lattice periodicity of the crystal-like superstructure thus formed is determined by the choice of particle size. For color effect coatings, the crystal-like superstructures must have a lattice periodicity in the refractive index course in the range of the wavelengths of the visible spectrum, that is, in the range of 380 nm≦d≦780 nm. Crucial for the optical quality of the color-effect coating is the strict periodicity in the refractive index curve and the high symmetry of the photonic crystal.

The self organization in crystal-like superstructures in a dispersant is advantageous particularly for silicon dioxide or titanium dioxide particles, because, for crystal-like superstructures of this kind, a large difference in refractive index exists between the particles themselves and the air-filled cavities. For creation of these air-filled cavities, the dispersant must be drawn off from the crystal-like superstructure. Because this is problematic, as described above, on account of the surface nature of the coating and the acting capillary forces, it is especially advantageous that the dispersant is drawn off by means of a hypercritical drying and thus a highly organized, crystal-like superstructure with air-filled intermediate spaces is formed, the lattice structure of which remains so uniform that the desired color effects are fully expressed. The advantageous effect of the process with a hypercritical drying may be seen in the fact that a porous coating material that produces a color effect can be obtained in an adequately stable manner essentially without the necklike material connections between the particles, which interfere with the optical properties of the coating. For example, the necklike connections interfere with the optical properties of the photonic crystal when color effect layers are used, because the strict periodicity of the filter is influenced in a detrimental way.

An inverse structure to the one described above represents an alternative color effect layer or an alternative color effect coating based on photonic crystals. To this end, a photonic crystal is prepared as a coating by sol-gel infiltration in a preform, a so-called template. In this process, a highly organized, crystal-like superstructure of the invention that does not have necklike connections between the particles forming the superstructure, as described above, is used as a template.

The invention will be illustrated below on the basis of the figures. Shown therein is the following:

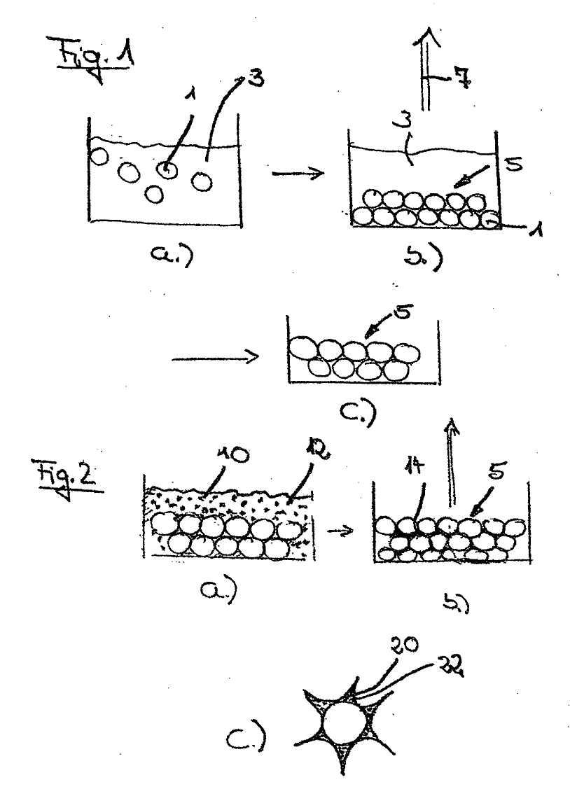

FIG. 1a-c the production of crystal-like superstructures, made from polymer spheres, TiO₂ or SiO₂ spheres, or other metal oxide spheres, by hypercritical drying,

FIG. 2a-c the production of crystal-like superstructures made from materials of high refractivity by sol-gel infiltration of a template and hypercritical drying of the sol-gel infiltrate,

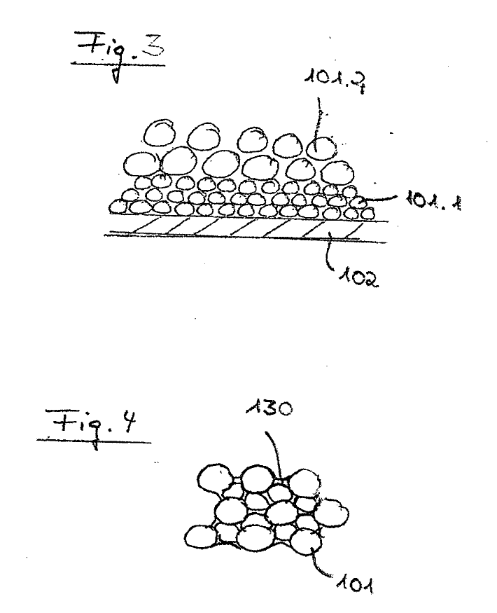

FIG. 3 a color effect coating on a substrate comprising two porous material layers with different spatial periodicity,

FIG. 4 a crystal-like superstructure in accordance with the prior art, wherein neck-shaped material connections for mechanical strengthening are formed between the particles that form the superstructure.

Shown in FIGS. 1a to 1c is the production of a crystal-like superstructure by addition of particles 1, preferably spheres with diameters of 10 nm to 10 μm, to a dispersant 3 and drawing off the dispersant. The particles can be polymer spheres, TiO₂ or SiO₂ spheres, or spheres made out of other organic or inorganic materials. Coming into consideration as polymer particles are, in particular, polystyrene (PS) or polymethyl methacrylate (PMMA) particles, preferably polystyrene (PS) or polymethyl methacrylate (PMMA) spheres. According to FIG. 1a, the particles are distributed in the solution 3 in an irregular manner. By sedimentation and self-organization or induced, controlled organization, the particles undergo organization into crystal-like, regular superstructures 5. This is shown in FIG. 1b. The dispersant still present in FIG. 1b is drawn off, preferably by hypercritical drying. There is then formed the solid 5 shown in FIG. 1c, which has a crystal-like superstructure. The solid 5 can itself be the photonic crystal in the case of TiO₂ or SiO₂ spheres, for example, or it may serve as the template for materials of high refractivity. If the solid 5 consists of TiO₂ spheres, then the solid 5 can be used, without further processing—for example, coating—as a porous material for the purification and treatment of water.

If the solid 5 is a crystal-like superstructure consisting, for example, of SiO₂ or polymer spheres, then the solid 5 constitutes the base material on which a coating containing TiO₂ or titanium oxide coating is applied, which then creates the functional layer for the purification and treatment of water. In particular, the functionality can be tailored by way of the coating.

If a polymeric solid with a crystal-like superstructure is used as the template, the photonic crystal with material of high refractivity, as shown in FIGS. 2a-2c, can be prepared by sol-gel infiltration with a material of high refractivity. According to FIG. 2a, for example, the polymeric solid with a crystal-like superstructure is added to a colloidal solution or sol 10. The colloidal solution comprises particles 12 with a size of between 5×10⁻¹⁰ and 2×10⁻⁷ m, which agglomerate and form a gel structure.

In the intermediate spaces 14 of the polymeric solid 5, which forms the template for the material of high refractivity, a gel structure is formed. The gel structure is dried in a hypercritical manner in accordance with the invention. The hypercritically dried structure is shown in FIG. 2c. The dried material of high refractivity is referred to by reference 20 and the microstructure that ensues on account of the microporosity by 22. In order to increase the difference in refractive index, the particles 1 of the template are dissolved out, for example, by baking in the case of solids constructed from polymer spheres as the template.

In contrast to an application in the field of optics, in which a large difference in refractive index between the regular structures must be produced, it is not necessary for the application of regularly structured photonic crystals for the immobilization of bacteria and other biological, microbiological, bioprocess technological, and medical applications to introduce a large difference in refractive index between the regular structures. This is very complex in the case of photonic crystals and is achieved, for example, with the method of inverse opals. The use of photonic crystals as color effect layers and coatings will be described below.

FIG. 3 shows a color effect layer on a substrate 102 with two porous, crystal-like organized layers 101.1, 101.2, which differ in their lattice periodicity. The two lattice periodicities of the refractive index should be chosen in such a way that only light of a wavelength that lies in the range of visible light, that is, between 380 nm and 780 nm, is reflected. Because each of the layers reflects selective wavelengths, there ensues for the observer, depending on the angle, the perception of mixed color, which, at the same time, is characterized by a opalescent effect. Here, however, a color effect coating of the invention can also be created by one porous layer with uniform lattice periodicity or with more than two different lattice periodicities.

The production of a crystal-like superstructure is described in FIGS. 1a-1c as well as in FIGS. 2a-2c, for the case when, for example, a polymeric solid with a crystal-like superstructure is used as the template.

FIG. 4 shows schematically, in a simplified way, a mechanical strengthening of the crystal-like superstructure due to the formation of necklike material connections 130 between the particles 101. A drawback of such a structure is that, as a rule, it cannot be controlled with adequate precision in terms of its growth, so that a deviation from the symmetrical structure and a distortion of the lattice results, which, for example, reduces the color effect of the coating or has other drawbacks in other applications, such as, for example, a reduced selectivity for application in the field of water treatment or in the immobilization of microorganisms.

Provided by the invention is, for the first time, a process for the production of highly organized superstructure materials, by means of which photonic crystals can also be prepared with relatively large dimensions in the range of several centimeters (cm) to decimeters (dm) for bulk materials and up to several meters (m) for coatings.

Furthermore, the invention provides porous materials that, in the IR wavelength region, act highly selectively as IR blockers—for example, as IR-blocking coating materials for window panes, automobile windows, lenses for glass, technical and scientific components with IR filter function, components for solar energy installations, and lamp bulb glasses as well as for electronic components. In solar energy installations, particularly thermal solar energy installations, it is possible with IR filters of this kind to substantially increase the efficiency. In the field of lamp bulb glasses and covers, the energy yield can likewise be increased substantially, because, as a result of the reflection of the substrate coated with an IR-blocking material, the reflected IR light is focussed back on the light source—for example, the filament. In the field of electronic components, an IR-blocking coating material can be employed in order to protect components of this kind from thermal radiation or too great a heating by neighboring hot components or by the surroundings. The IR-blocking layer in accordance with the invention can be deposited on a substrate by means of a dipping process, a spin-deposition process, or a spraying process. Coming into consideration as a substrate materials for the IR-blocking layers are all kinds of glasses, transparent base materials, or other transparent substrates, but also opaque substrates, such as metals and ceramics.

Furthermore, the invention provides porous materials that act highly selectively as UV blockers in the UV wavelength region, for example, as UV-blocking coating material for window panes, automobile windows, lenses for glasses, particularly sunglass lenses, and technical and scientific components with UV filter function. The UV-blocking layer in accordance with the invention can be deposited on a substrate by means of a dipping process, a spin-deposition process, or a spraying process. Preferably, as described above, the photonic crystals can be prepared directly by sol-gel methods. Coming into consideration as substrate materials for the UV-blocking layers are all kinds of glasses, transparent base materials, or other transparent substrates, but also opaque substrates, such as metals and ceramics for reflective optics.

Furthermore, the invention provides, for the first time, a porous material and a process with which, in particular, bacteria can be immobilized in a highly specific manner in bioprocess technological and medical applications.

Also provided, for the first time, are porous materials and a production process with which it is possible to produce catalyst supports with a very regular pore size as well as porous materials with which, in particular, bacteria can be immobilized in a highly specific manner in bioprocess technological and medical applications.

1. A process for the production of materials with crystal-like superstructure or inverse crystal-like superstructure, comprising:
initiating a self-organization process or an induced, controlled processes; and
hypercritically drying to leave the materials with crystal-like superstructure or inverse crystal-like superstructure.

2. The process according to claim 1, wherein the initiating comprises adding particles to a dispersant so that the particles undergo organization in the dispersant by slow sedimentation and the self-organization process or the induced, control process to form the crystal-like superstructure or the inverse crystal-like superstructure.

3. The process according to claim 2, further comprising drawing off the dispersant by drying, and filling preform with the materials that form the inverse crystal-like superstructure by sol-gel infiltration to define a sol-gel infiltrate, and wherein the hypercritically drying of the sol-gel infiltrate forms the inverse crystal-like superstructure.

4. The process according to claim 3, wherein drawing off the dispersant comprises a second hypercritical drying.

5. The process according to claim 3, further comprising dissolving the preform out of the inverse crystal-like superstructure.

6. The process according to claim 5, wherein the dissolving comprises baking the preform.

7. The process according to claim 2, wherein the particles are metal oxide particles.

8. The process according to claim 2, wherein the particles are plastic particles.

9. The process according to claim 2, wherein the particles have a size in range of 10 nm to 10 μm.

10. The process according to claim 3, wherein the sol-gel infiltrate comprises a TiO₂ sol-gel or an SiO₂ sol-gel.

11. The process according to claim 3, wherein the filling by sol-gel infiltration comprises forming a colloidal solution or sol having particles with a size between 5×10⁻¹⁰ and 2×10⁻⁷ m that agglomerate and form a gel structure.

12. A porous material for the blocking of IR radiation, comprising:
a crystal-like superstructure or inverse crystal-like superstructure formed from plurality of particles,
and a plurality of cavities, the plurality of cavities having characteristic dimensions that largely correspond to characteristic dimensions in photonic crystals, wherein the crystal-like or inverse crystal-like superstructure has a regular spacing that lies in a range of greater than or equal to 0.7 μm but less than or equal to 100 μm.

13. The porous material according to claim 12, wherein the regular spacing lies in the range of greater than or equal to 1.0 μm but less than or equal to 100 μm.

14. The porous material according to claim 12 wherein the porous material is a colloidal crystal with the crystal-like superstructure.

15. The porous material according to claim 14, wherein the colloidal crystal is selected from the group consisting of a polymeric colloidal crystal, a titanium dioxide colloidal crystal, and a silicon dioxide colloidal crystal.

16. The porous material according to claim 14, wherein the colloidal crystal is a polymeric colloidal crystal that comprises polystyrene particles or polymethyl methacrylate particles.

17. The porous material according to claim 12, further comprising a highly refractive material that is molded with a structure of a colloidal crystal to form the inverse crystal-like superstructure.

18. The porous material according to claim 17, wherein the highly refractive material is selected from the group consisting of
TiO₂,
InP, and
CdSe.

19. The porous material according to claim 17, wherein the highly refractive material and the colloidal crystal are prepared by sol-gel infiltration.

20. The porous material according to claim 19, wherein the highly refractive material and the colloidal crystal are dried in a hypercritical manner.

21. The porous materials according to claim 12, wherein the porous materials is prepared by a self-organization process or an induced, controlled processes and hypercritical drying to leave the crystal-like superstructure or inverse crystal-like superstructure.

22. A composite material, comprising:
a substrate material; and
a porous material having a crystal-like superstructure or inverse crystal-like superstructure formed from a plurality of particles and a plurality of cavities, the plurality of cavities having characteristic dimensions that largely correspond to characteristic dimensions in photonic crystals, wherein the crystal-like or inverse crystal-like superstructure has a regular spacing that lies in the a range of greater than or equal to 0.7 μm but less than or equal to 100 μm, and
wherein the porous material is applied to the substrate material by dipping, spin-deposition, or spraying processes.

23. The composite material according to claim 22, wherein the substrate material is selected from the group consisting of
window panes,
automobile windows,
lenses for glasses,
components for technical and scientific instruments with IR filter function, coated components for solar energy installations,
coated lamp bulb glasses, and
coated electronic components.

24. (canceled)

25. A porous material for the blocking of UV radiation, comprising:
a crystal-like or inverse crystal-like superstructure formed from a regular structure made up of particles and having various regularly arranged cavities lying within a distribution corresponding to distribution of characteristic dimensions in photonic crystals,
wherein the crystal-like or inverse crystal-like superstructure has a regular spacing that lies in the range of greater than or equal to 3 nm but less than or equal to 300 nm.

26. The porous material according to claim 25, wherein the regular spacing lies in the range of greater than or equal to 10 nm but less than or equal to 280 nm.

27. The porous material according to claim 25, wherein the porous material is a colloidal crystal with the regular crystal-like superstructure.

28. The porous material according to claim 27, wherein the colloidal crystal is selected from the group consisting of a polymeric colloidal crystal, a titanium dioxide colloidal crystal, and a silicon dioxide colloidal crystal.

29. The porous material according to claim 28, wherein the colloidal crystal is a polymeric colloidal crystal that comprises polystyrene particles or polymethyl methacrylate particles.

30. The porous material according to claim 25, further comprising highly refractive material that is molded with a structure of a colloidal crystal to form the inverse crystal-like superstructure.

31. The porous material according to claim 30, wherein the highly refractive material is selected from the group consisting of
TiO₂,
InP, and
CdSe.

32. The porous material according to claim 30, wherein the highly refractive material and the colloidal crystal are prepared by sol-gel infiltration.

33. The porous material according to claim 32, wherein the highly refractive material and the colloidal crystal are dried in a hypercritical manner.

34. The porous material according to claim 25, wherein the crystal-like superstructure or inverse crystal-like superstructure is obtained by sedimentation in a dispersant and subsequent drawing off of the dispersant by hypercritical drying.

35. A composite material, comprising:
a substrate material; and
a porous material for the blocking of UV radiation, the porous material having a crystal-like or inverse crystal-like superstructure formed from a regular structure made up of particles and having various regularly arranged cavities lying within a distribution corresponding to a distribution of characteristic dimensions in photonic crystals,
wherein the crystal-like or inverse crystal-like superstructure has a regular spacing that lies in the range of greater than or equal to 3 nm but less than or equal to 300 nm and wherein the porous material is applied to the substrate material by dipping, spin-deposition, or spraying processes.

36. The composite material according to claim 35, wherein the substrate material is selected from the group consisting of
window panes,
automobile windows,
lenses for glasses,
components for technical and scientific instruments with UV filter function,
components for solar energy installations,
lamp bulb glasses,
electronic components,
viewing windows for UV sterilizers, and
reflecting optics and components for extremely short-wavelength UV radiation.

37. The porous material according to claim 25, wherein the porous material finds use as UV-blocking coating material for a material selected from the group consisting of
window panes,
automobile windows, lenses for glasses, and
components for technical and scientific instruments with UV filter function.

38-73. (canceled)
